(19) United States
(12) Patent Application Publication
(10) Pub. No.: US 2026/0112349 A1
(43) Pub. Date: Apr. 23, 2026

(54) ADDING FOAM TO ACOUSTIC CAVITIES OF AUDIO DEVICES

(71) Applicant: Meta Platforms Technologies, LLC, Menlo Park, CA (US)

(72) Inventors: Robert True, Pleasant Prairie, WI (US); Simon Porter, San Jose, CA (US); Zhi Lu, Zhuhai (CN)

(21) Appl. No.: 19/228,578

(22) Filed: Jun. 4, 2025

(30) Foreign Application Priority Data
Oct. 23, 2024 (WO) PCT/CN2024/126814

(51) Int. Cl. G10K 11/00; H04R 1/02

(52) U.S. Cl. CPC G10K 11/002; H04R 1/02

(57) ABSTRACT

An apparatus of the subject technology includes a speaker to receive audio signals and to generate a soundwave output, and an output port to provide the soundwave output to a user. The apparatus further includes an enclosure containing the speaker and a cavity formed between the speaker and the output port, and an acoustic damping medium placed in the cavity and configured to cancel acoustic standing waves.

### CROSS REFERENCE TO RELATED APPLICATIONS

The present application claims the benefit of priority under 35 U.S.C. § 111 to International Application No. PCT/CN2024/126814, filed on Oct. 23, 2024, the entire contents of which are incorporated herein by reference in their entirety.

### TECHNICAL FIELD

The present disclosure generally relates to audio systems, and more particularly, to adding foam to acoustic cavities of audio devices.

### BACKGROUND

Acoustic absorbers such as foam or fibrous materials are often used in speaker enclosures to reduce standing waves and enclosure wall flex. These materials are often applied as linings to the enclosure or as simple packed stuffing. Speaker modules for mixed reality (MR) headsets have to conform to a size and/or shape specified by industrial design (ID) and use plastics specified by the product design (PD). This typically means that the speaker enclosure is not ideal for sound reproduction in terms of internal cavity dimensions and plastic wall thickness. As a result, excessive and/or undesirable distortion is often present, especially at loud listening levels.

### SUMMARY

In some aspects, the subject disclosure relates to an apparatus of the subject technology and includes a speaker to receive audio signals and to generate a soundwave output, and one or more output ports to provide the soundwave output to a user. The apparatus further includes an enclosure containing the speaker and cavities formed between the speaker and the output ports, and an acoustic damping medium placed in the cavity and configured to reduce acoustic standing waves.

In some other aspects, the subject disclosure relates to an MR device including an audio unit that comprises one or more output ports to provide to a user a soundwave output played by a speaker. The audio unit further includes an enclosure configured to contain the speaker and provide a cavity between the speaker and the output ports, and a foam placed in the cavity to reduce acoustic standing waves.

In yet other aspects, the subject disclosure relates to a method including providing an audio unit including a speaker and an sound output port contained in an enclosure and configuring the speaker to receive audio signals and to generate an audio output. The method also includes configuring the sound output port to provide the soundwave output to a user and configuring the enclosure to form a cavity between the speaker and one or more sound output ports. The method further includes placing in the cavity an acoustic damping medium configured to reduce acoustic standing waves.

### BRIEF DESCRIPTION OF THE DRAWINGS

To easily identify the discussion of any particular element or act, the most significant digit or digits in a reference number refer to the figure number in which that element is first introduced.

FIGS. 1A and 1B are schematic diagrams illustrating examples of an audio unit without and with an acoustic foam, according to some aspects of the subject technology.

FIG. 2 is a chart illustrating example plots of sound pressure level (SPL) in dB for an audio unit of an MR device, according to some aspects of the subject technology.

FIG. 3 is a chart illustrating example plots of total distortion (TD) versus frequency for an audio unit of an MR device, according to some aspects of the subject technology.

FIG. 4 is a chart illustrating example plots of higher order harmonic distortion (HOHD) versus frequency for an audio unit of an MR device, according to some aspects of the subject technology.

FIG. 5 is a chart illustrating example plots of intermodulation distortion (IMD) versus frequency for an audio unit of an MR device, according to some aspects of the subject technology.

FIG. 6 is a chart illustrating example plots of perceptual rub and buzz (PRB) versus frequency for an audio unit of an MR device, according to some aspects of the subject technology.

FIGS. 7A, 7B, 7C and 7D are charts illustrating example plots of first pass yield (FPY) versus configuration for an audio unit of an MR device, according to some aspects of the subject technology.

FIGS. 8A, 8B, 8C and 8D are schematic diagrams illustrating examples of audio units with different foam configurations, according to some aspects of the subject technology.

FIG. 9 is a flow diagram illustrating an example of a method of providing an audio unit with an acoustic foam, according to some aspects of the subject technology.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below describes various configurations of the subject technology and is not intended to represent the only configurations in which the subject technology may be practiced. The detailed description includes specific details for the purpose of providing a thorough understanding of the subject technology. Accordingly, dimensions may be provided in regard to certain aspects as non-limiting examples. However, it will be apparent to those skilled in the art that the subject technology may be practiced without these specific details. In some instances, well-known structures and components are shown in block diagram form in order to avoid obscuring the concepts of the subject technology.

It is to be understood that the present disclosure includes examples of the subject technology and does not limit the scope of the included clauses. Various aspects of the subject technology will now be disclosed according to particular but non-limiting examples. Various embodiments described in the present disclosure may be carried out in different ways and variations, and in accordance with a desired application or implementation.

In the following detailed description, numerous specific details are set forth to provide a full understanding of the present disclosure. It will be apparent, however, to one ordinarily skilled in the art, that embodiments of the present disclosure may be practiced without some of the specific details. In other instances, well-known structures and techniques have not been shown in detail so as not to obscure the disclosure.

Some aspects of the subject disclosure are directed to solving the technical problem of audio distortions and acoustic vibrations in audio devices, for example, of an MR headset. The subject technology solves the technical problem by adding an acoustic damping medium such as an acoustic foam (hereinafter, foam) to acoustic cavities of audio devices by placing one or more foam pieces with specific acoustic properties in one or more of the enclosure internal cavities. In MR headset speaker modules, for example, at some frequencies where sound wavelengths are fractionally related to the internal cavity dimensions, acoustic standing waves are setup. This can result in excessively high internal sound-pressure levels that can cause an undesired unevenness in the pressure frequency response. Further, an increase in non-linear distortion as noted, for example, in high total harmonic distortion (THD), high order hormonic distortion (HOHD), and intermodulation distortion (IMD) measurements is often noted at these frequencies. Broadband distortion can also result in these types of modules at frequencies where high velocity air flow is present through small internal cavities, speaker motor gaps, and exit ports. These various distortion mechanisms can lead to a degraded listening experience.

The module enclosure is typically made with thin-wall plastic or other materials and the high internal pressure pushing against the walls can cause them to flex, further causing distortion. The walls can also resonate at some frequencies in response to the pressure excitation, sometimes to extreme levels that exacerbate the problems.

The subject technology reduces these effects by strategically placing one or more foamed pieces with specific acoustic properties in one or more of the enclosure internal cavities. By doing this, some of the sound is absorbed by the foam so the total sound pressure build up is reduced. Furthermore, the foam, when compressed between the walls of the enclosure, will also reduce vibration in the plastic by acting as a stiffener and an absorber. Both effects can smooth the frequency response and/or lower distortion. The air flow noise at resonance frequencies can also be reduced by reducing the internal velocity.

In some implementations, by shaping the foam pieces, the disclosed technology routes the sound waves between the speaker driver and exit ports in a way that improves the frequency response without significantly reducing the less distorted output of the module. In some implementations, special features can be included in the shaped foam pieces. For example, cuts in the material that form channels or pockets with specific dimensions (e.g., within a range of about 1-5 mm) can create resonators that reduce the pressure build up at one or more frequencies. In some implementations, some of the walls of the foam may be coated, somehow heat sealed, or lined with other materials to make them acoustically less absorbent or even reflective. In doing so, the center frequencies and bandwidth of the resonators can be tuned to reduce acoustic resonances at specific frequencies.

In some implementations, by controlling the amount of foam compression between two or more walls of the enclosure, the subject technology significantly reduces the vibration in the plastic wall while maintaining effective acoustic absorption properties. In some implementations, the amount of compression can be controlled with the thickness of the foam piece before it is inserted into the cavity. In some implementations, the thickness is selected based on the foam desired density in the compressed state.

In some implementations, memory foam can be used in this application where it is compressed prior to module assembly so that it sits flattened against one or more of the walls before the module enclosure pieces are brought together. After assembly is completed, the memory foam expands to the desired level of compression as it fills the internal cavity and pushes against the opposite side walls. This method of foam installation makes it easier to bring the plastic parts together with proper alignment before it starts pushing against the opposing plastic walls. For example, in the case when the plastic parts are ultrasonically welded, this allows time for the weld to be completed before foam contacts the surfaces to be welded where it can cause an inferior weld or a longer welding cycle. Similarly, if the plastic parts are glued together, fixture time for the adhesive can be reached before the foam begins to push against them.

Adding foam improves the listening experience by reducing distortion. This allows the product to play louder with better low frequency extension. Further, by reducing variation and high distortion values, the yield is increased, and the overall cost is reduced.

The subject technology can be adopted to be used in audio devices that have acoustic cavities and ports where internal standing waves or resonances cause distortion, frequency response anomalies, and variation in both.

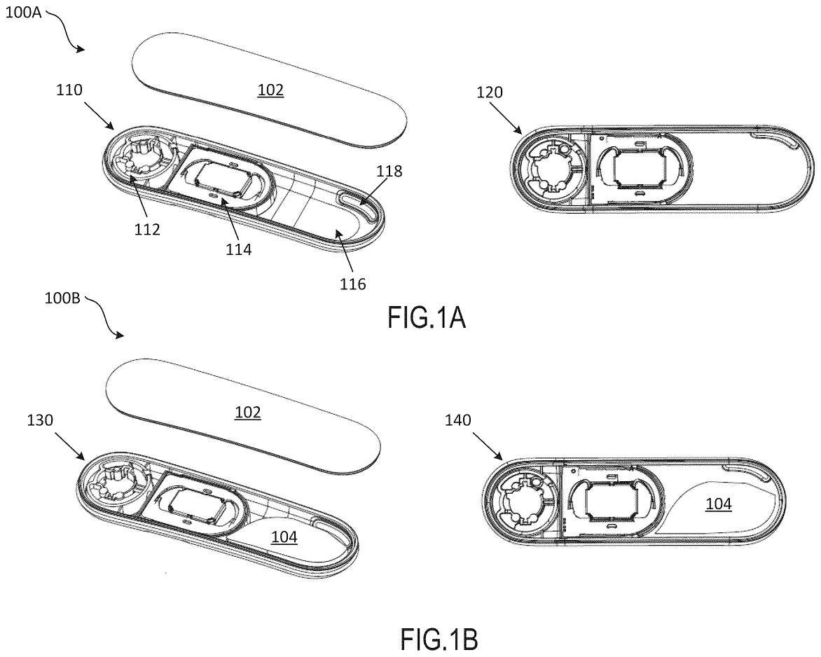

Turning now to the figures, FIGS. 1A and 1B are schematic diagrams illustrating examples of audio units 100A and 100B without and with an acoustic foam, according to some aspects of the subject technology. The audio unit 100A includes a top 102 (lead) and a body with an internal structure shown by a three-dimensional (3D) view 110 and a top view 120. As shown in the 3D view, the audio unit 100A includes an interface module 112, a speaker module 114, a cavity 116, and an audio port 118. The speaker module 114 is connected to an audio amplifier by wires carrying a voltage (not shown.) The sound output generated by the speaker module 114 can travel through the cavity 116 to the audio port 118 (e.g., an exit port) for reaching to the user's ears.

The problem with the audio unit 100A is that at some frequencies where sound wavelengths are fractionally related to the dimensions of the cavity 116, acoustic standing waves are formed. The formation of the standing waves can result in excessively high internal sound-pressure levels that can cause an undesired unevenness in the pressure frequency response. Furthermore, non-linear distortions such as THD, HOHD, and IMD can increase, which leads to a degraded listening experience.

The audio unit 100B includes the top 102 and a body similar to the body of the audio unit 100A with an internal structure shown by a 3D view 130 and a top view 140. As shown in the 3D view 130, the audio unit 100B includes an acoustic damping medium (e.g., foam) 104 (hereinafter, foam 104) in the cavity 116 to mitigate the shortcomings of the audio unit 100A such as formation of the acoustic standing waves and nonlinear distortions, which are prevented by placing the foam 104 in the cavity 116.

In some implementations, the amount of compression of the foam 104 is controlled to significantly reduce the vibration in the plastic walls (e.g., the top 102 and a bottom wall) while maintaining effective acoustic absorption properties. In some implementations, the amount of compression can be controlled with the thickness of the foam 104 before it is inserted into the cavity 116. In some implementations, the thickness is selected based on the foam desired density in the compressed state. In some implementations, the foam 104 can be a memory foam used to sit flattened against the walls before the module enclosure pieces are brought together. After assembly is completed, the memory foam can expand to the desired level of compression. The foam (or fibrous material) 104 may be a low-density foam or a high-density foam, open cell or closed cell, with different cell sizes and with and without features such as cuts, as discussed below with differing effects on the acoustic performance. In some implementations, a piece of foam may also be used on top of the speaker module 114.

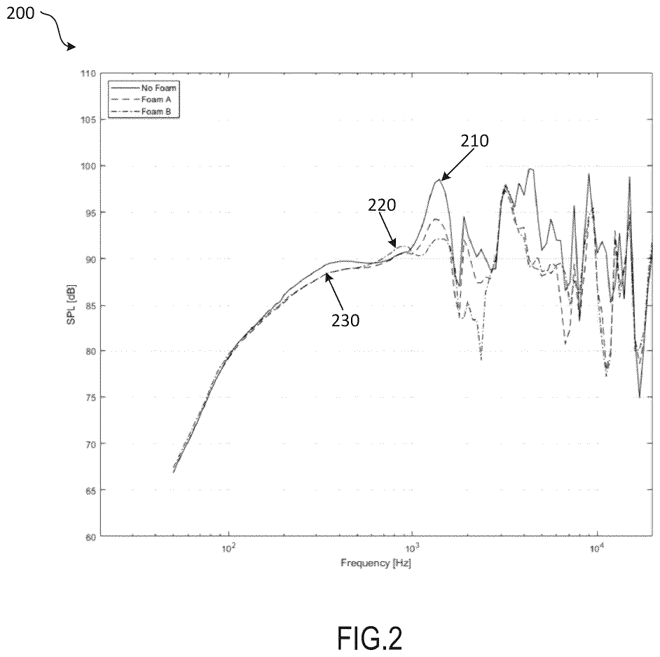

FIG. 2 is a chart 200 illustrating example plots 210, 220 and 230 of SPL in dB versus frequency for an audio unit of an MR device, according to some aspects of the subject technology. The audio unit can be one of the audio units 100A or 100B of FIGS. 1A and 1B discussed above. The plot 210 corresponds to the audio unit 100A, which has no foam. The plot 220 is associated with the audio unit 100B, with the foam 104 being a foam type A, which can be a low-density foam. The plot 230 corresponds to the audio unit 100B, with foam type B, for example, a high-density foam. It is clear from the plots 210, 220 and 230 that the lowest SPL at many frequencies is achieved with the type B foam. This indicates that the subject technology can control the SPL with different choices of the foam and can achieve a desired SPL by adjusting the properties of the foam 104 such as the foam material, dimensions, composition and/or density.

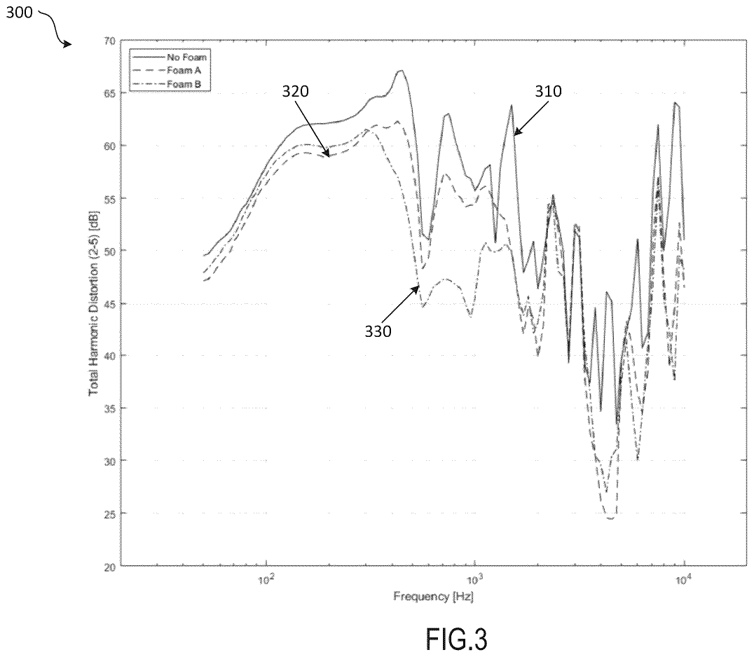

FIG. 3 is a chart 300 illustrating example plots 310, 320 and 330 of THD versus frequency for an audio unit of an MR device, according to some aspects of the subject technology. The audio unit can be one of the audio units 100A or 100B of FIGS. 1A and 1B discussed above. The plot 310 corresponds to the audio unit 100A, which has no foam. The plot 320 is associated with the audio unit 100B, with the foam 104 being a foam type A (e.g., a low-density foam). The plot 330 corresponds to the audio unit 100B, with foam type B, for example, a high-density foam. The plots 310, 320 and 330 indicate that the lowest THD at many frequencies is achieved with the type B foam. Accordingly, the subject technology can control the THD with different choices of the foam and can achieve a desired THD by adjusting the properties of the foam 104 such as the foam material, dimensions, composition and/or density.

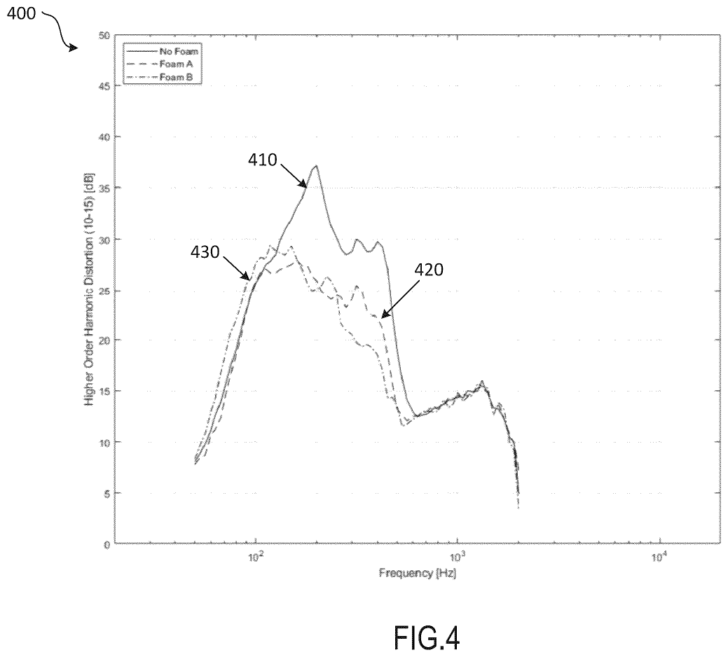

FIG. 4 is a chart 400 illustrating example plots 410, 420 and 430 of HOHD10-15 (10^{th} through 15^{th} Harmonics Included) in dB versus frequency for an audio unit of an MR device, according to some aspects of the subject technology. The audio unit can be one of the audio units 100A or 100B of FIGS. 1A and 1B discussed above. The plot 410 corresponds to the audio unit 100A, which has no foam. The plot 420 is associated with the audio unit 100B, with the foam 104 being a foam type A (e.g., a low-density foam). The plot 430 corresponds to the audio unit 100B, with foam type B, for example, a high-density foam. The plots 410, 420 and 430 indicate that the lowest HOHD at higher frequencies (e.g., above about 200 Hz) is achieved with the type B foam. Accordingly, the subject technology can control the HOHD with different choices of the foam and can achieve a desired HOHD by adjusting the properties of the foam 104 such as the foam material, dimensions, composition and/or density.

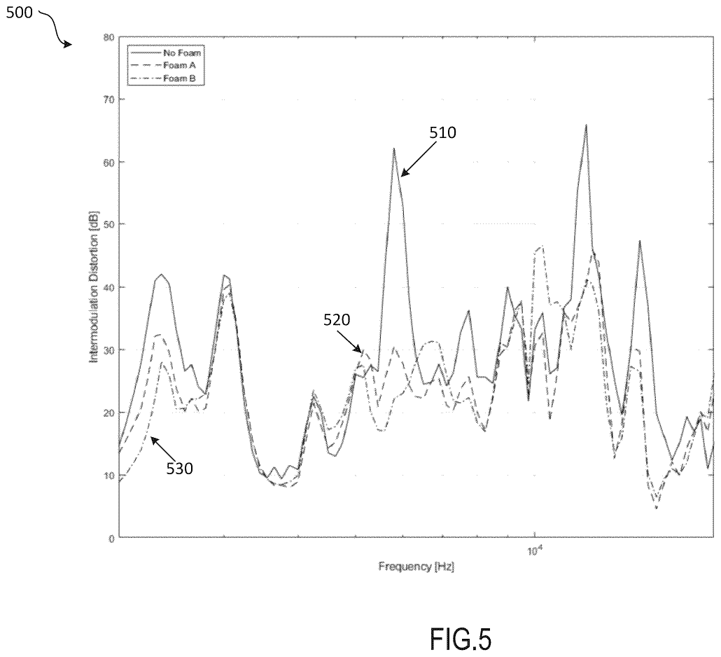

FIG. 5 is a chart 500 illustrating example plots 510, 520 and 530 of IMD in dB versus frequency for an audio unit of an MR device, according to some aspects of the subject technology. The audio unit can be one of the audio units 100A or 100B of FIGS. 1A and 1B discussed above. The plot 510 corresponds to the audio unit 100A, which has no foam. The plot 520 is associated with the audio unit 100B, with the foam 104 being a foam type A (e.g., a low-density foam). The plot 530 corresponds to the audio unit 100B, with foam type B, for example, a high-density foam. The plots 510, 520 and 530 indicate that the IMD can be lowered by using a foam. At low frequencies, the foam type B seems to be the best choice, whereas at higher frequencies any foam is better that no foam. Accordingly, the subject technology can control the IMD with different choices of the foam and can achieve a desired IMD at certain frequencies by adjusting the properties of the foam 104 such as the foam material, dimensions, composition and/or density.

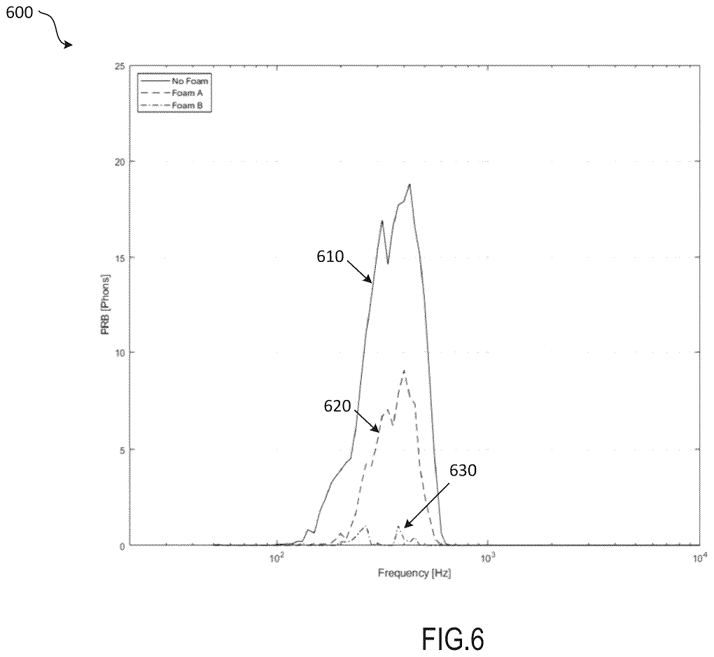

FIG. 6 is a chart 600 illustrating example plots 610, 620 and 630 of PRB in Phons versus frequency for an audio unit of an MR device, according to some aspects of the subject technology. The PRB is a measure of audible distortion in loudspeakers and other audio devices. The PRB is particularly useful because it focuses on whether the distortion can be heard by the listener, making it more relevant for assessing the actual audio quality experienced by users. The PRB is also less sensitive to transient background noises, making it reliable in noisy environments.

The audio unit can be one of the audio units 100A or 100B of FIGS. 1A and 1B discussed above. The plot 610 corresponds to the audio unit 100A, which has no foam. The plot 620 is associated with the audio unit 100B, with the foam 104 being a foam type A (e.g., a low-density foam). The plot 630 corresponds to the audio unit 100B, with foam type B, for example, a high-density foam. The plots 610, 620 and 630 indicate that the lowest PRB at almost all frequencies can be achieved with the type B foam. Accordingly, the subject technology can control the PRB with different choices of the foam and can achieve a desired PRB by adjusting the properties of the foam 104 such as the foam material, dimensions, composition and/or density.

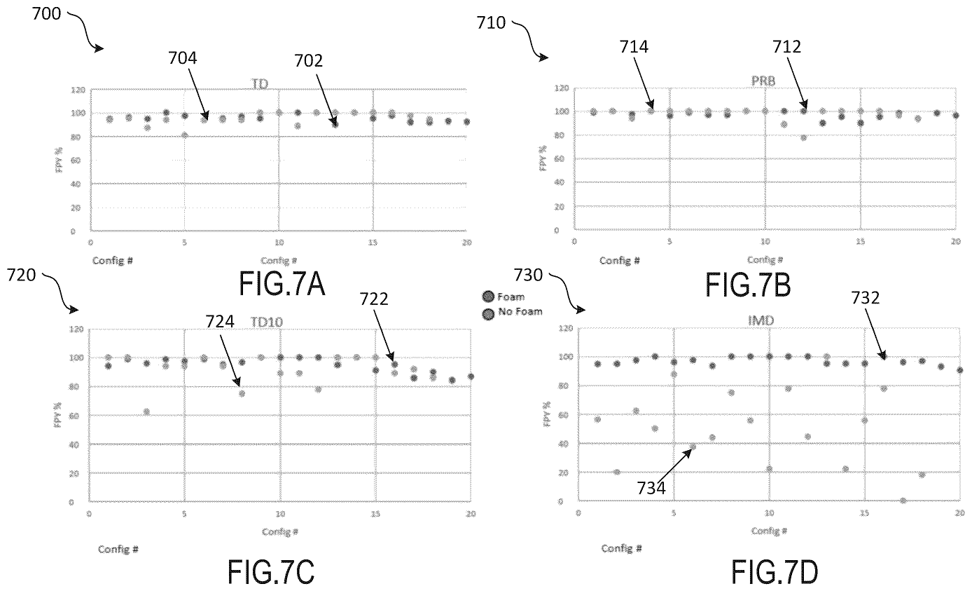

FIGS. 7A, 7B, 7C and 7D are charts 700, 710, 720 and 730 illustrating example plots of FPY versus configuration for an audio unit of an MR device, according to some aspects of the subject technology. The chart 700 includes plots 702 and 704, which show FPY in percent, at a fixed TD, versus configuration number for an audio unit with foam (e.g., 100B of FIG. 1B) and without foam (e.g., 100A of FIG. 1A), respectively. The configuration number identifies various configurations that relate to different manufacturers, manufacturing tools and materials used. The plots 702 and 704 show that using foam for some configurations may somewhat improve the FPY.

The chart 710 includes plots 712 and 714, which show FPY in percent, at a fixed PRB, versus configuration number for an audio unit with foam and without foam, respectively. The plots 712 and 714 show that using foam for only a few configurations may somewhat improve the FPY.

The chart 720 includes plots 722 and 724, which show FPY in percent, at a fixed third harmonic (TD)10, versus configuration number for an audio unit with foam and without foam, respectively. The plots 722 and 724 show that using foam for a few configurations may somewhat improve the FPY.

The chart 730 includes plots 732 and 734, which show FPY in percent, at a fixed IMD, versus configuration number for an audio unit with foam and without foam, respectively. The plots 732 and 734 show that using foam for almost all configurations can improve the FPY.

The charts 700, 710, 720 and 730 overall indicate that using the foam makes the FPY independent of configuration number, which is a desired feature of the subject technology.

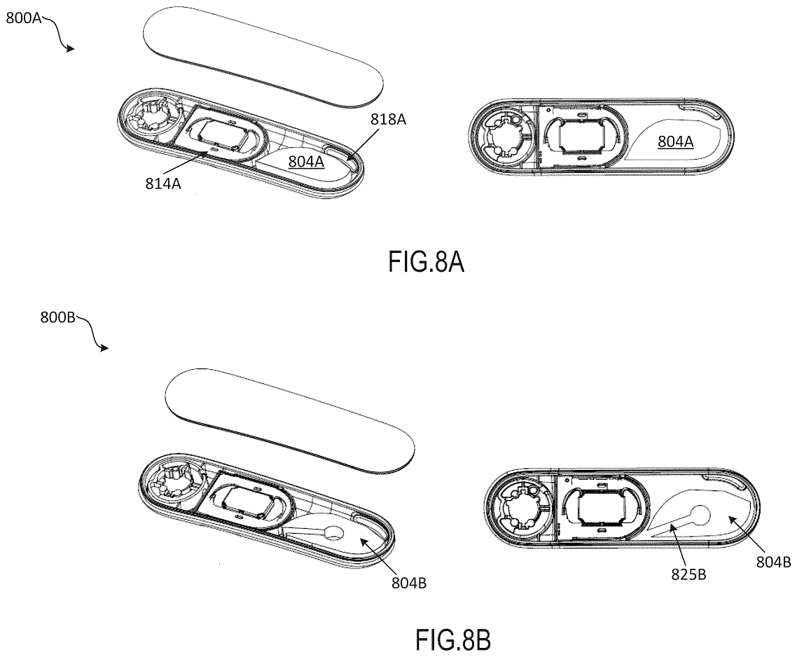

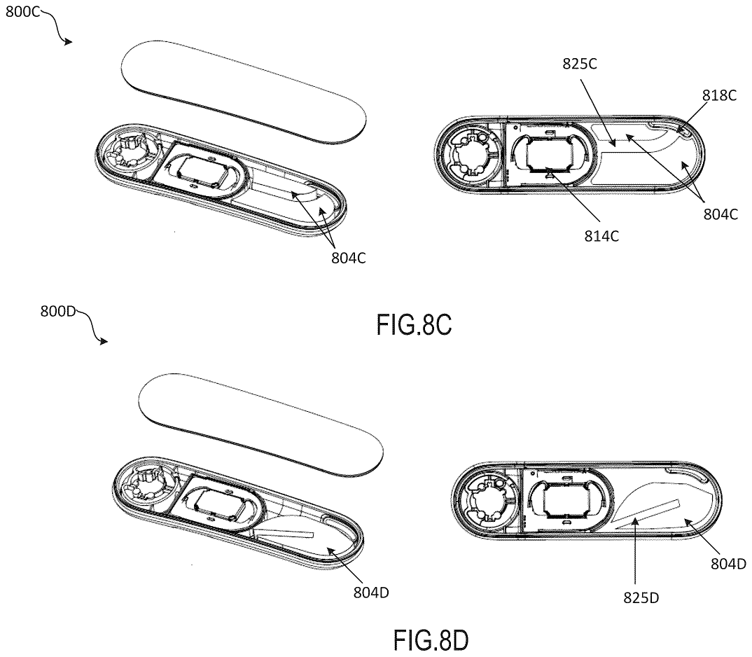

FIGS. 8A, 8B, 8C and 8D are schematic diagrams illustrating examples of audio units 800A, 800B, 800C and 800D with different foam configurations, according to some aspects of the subject technology. The audio unit 800A is similar to the audio unit 100B of FIG. 1B, except for the dimensions of foam 804A that allows for some room around the foam 804A to form an audio channel for the audio output from the speaker 814A to reach the audio port 818A.

The audio unit 800B is similar to the audio unit 800A, except for the configuration of a foam 804B, which includes a special cut that can act as a resonator (e.g., a Helmholtz resonator). When the dimensions of the resonator are selected to relate to (e.g., be tuned with) the wavelength of the acoustic standing wave inside the audio unit, the resonator can cancel those acoustic standing waves.

The audio unit 800C is similar to the audio unit 800A, except for the configuration of a foam 804C, which is formed of two pieces that forms a special cut 825C that can provide a direct audio channel between the speaker 814C and the audio port 818C.

The audio unit 800D is similar to the audio unit 800C, except for the configuration of a foam 804D, which has a special cut 825D that can be configured to affect the audio performance of the audio unit 800D.

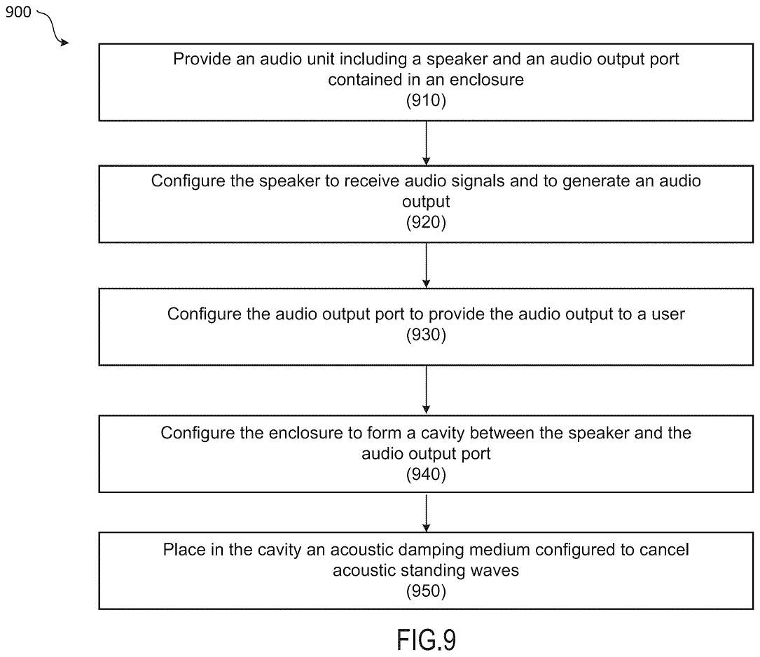

FIG. 9 is a flow diagram illustrating an example of a method 900 of providing an audio unit with an acoustic foam, according to some aspects of the subject technology. For the sake of explanation, the method 900 is shown with reference to components of audio units 100A and 100B of FIGS. 1A and 1B. The method 900 includes process steps 910, 920, 930, 940 and 950.

In step 910, an audio unit (e.g., 100A of FIG. 1A) including a speaker (e.g., 114 of FIG. 1A) and a sound output port (e.g., 118 of FIG. 1A) contained in an enclosure is provided, which is an output port for the generated sound wave.

In step 920, the speaker is configured to receive audio signals and to generate sound waves.

In step 930, the sound waves port is configured to provide the audio output to a user.

In step 940, the enclosure is configured to form a cavity (e.g., 116 of FIG. 1A) between the speaker and the sound output port.

In step 950, an acoustic damping medium (e.g., 104 of FIG. 1B) is placed in the cavity and is configured to cancel acoustic standing waves.

An aspect of the subject technology is directed to an apparatus of the subject technology and includes a speaker to receive audio signals and to generate sound waves, and an output port to provide the sound waves to a user. The apparatus further includes an enclosure containing the speaker and a cavity formed between the speaker and the output port, and an acoustic damping medium placed in the cavity and configured to cancel acoustic standing waves.

In some implementations, the acoustic damping medium includes a foam and is further configured to dampen vibrations of side walls of the cavity.

In one or more implementations, the foam includes a compressed memory foam configured to expand to a level of compression sufficient to fill the cavity and to push against the side walls of the cavity.

In some implementations, the acoustic damping medium includes a foam, wherein the foam is configurable by changing foam properties including a material, a shape, a dimension and a density.

In one or more implementations, the foam is configured to reduce a distortion and improve a user experience.

In some implementations, the foam is configured to improve a perceptual rub and buzz (PRB) measure of a distortion.

In one or more implementations, the foam is configured to allow the speaker to play louder with reduced low frequency extension.

In some implementations, the foam is configured to reduce HOHD and IMD values.

In one or more implementations, the foam is configured to increase a production yield and reduce an overall production cost.

In some implementations, one or more walls of the foam are coated with a material to improve acoustic properties by making the one or more walls acoustically less absorbent or reflective.

Another aspect of the subject technology is directed to an MR device including an audio unit that includes an output port to provide to a user sound waves played by a speaker. The audio unit further includes an enclosure configured to contain the speaker and provide a cavity between the speaker and the output port, and placing a foam in the cavity to cancel acoustic standing waves.

In some implementations, the audio unit is an attachable unit configured to use a universal serial bus (USB) interface. (I don't think this is necessary) In one or more implementations, the foam is configurable by changing foam properties including a material, a shape, a dimension and a density.

In some implementations, the foam is configured to allow the speaker to play louder with a reduced distortion and to improve a user experience.

In one or more implementations, the foam is configured to improve a PRB measure of a distortion.

In some implementations, the foam is configured to reduce HOHD and IMD values.

In one or more implementations, one or more walls of the foam are lined with a material to improve acoustic properties by making the one or more walls acoustically less absorbent or reflective.

Yet another aspect of the subject technology is directed to a method including providing an audio unit including a speaker and sound output port contained in an enclosure and configuring the speaker to receive audio signals and to generate sound output. The method also includes configuring the sound output port to provide the sound output to a user and configuring the enclosure to form a cavity between the speaker and the sound output port. The method further includes placing in the cavity an acoustic damping medium configured to cancel acoustic standing waves.

In one or more implementations, the foam is configurable by changing foam properties including a material, a shape, a dimension and a density, the foam is configured to reduce HOHD and IMD values, and one or more walls of the foam are coated or lined with a material to improve acoustic properties by making the one or more walls acoustically less absorbent or reflective.

In some implementations, the word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially described as such, one or more features from a described combination can in some cases be excised from the combination, and the described combination may be directed to a sub-combination or variation of a sub-combination.

The subject matter of this specification has been described in terms of particular aspects, but other aspects can be implemented and are within the scope of the following clauses. For example, while operations are depicted in the drawings in a particular order, this should not be understood as requiring that such operations be performed in the particular order shown or in sequential order, or that all illustrated operations be performed, to achieve desirable results. The actions recited in the clauses can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the clauses. In addition, in the detailed description, it can be seen that the description provides illustrative examples, and the various features are grouped together in various implementations for the purpose of streamlining the disclosure. The method of disclosure is not to be interpreted as reflecting an intention that the described subject matter requires more features than are expressly recited in each clause. Rather, as the clauses reflect, inventive subject matter lies in less than all features of a single disclosed configuration or operation. The clauses are hereby incorporated into the detailed description, with each clause standing on its own as a separately described subject matter.

As used herein, the phrase “at least one of” preceding a series of items, with the terms “and” or “or” to separate any of the items, modifies the list as a whole, rather than each member of the list (i.e., each item).

To the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. An apparatus, comprising:
a speaker configured to receive audio signals and to generate a soundwave output;
an output port configured to provide the soundwave output to a user;
an enclosure containing the speaker and a cavity formed between the speaker and the output port; and
an acoustic damping medium placed in the cavity and configured to cancel acoustic standing waves.

2. The apparatus of claim 1, wherein the acoustic damping medium comprises a foam and is further configured to dampen vibrations of side walls of the cavity.

3. The apparatus of claim 2, wherein the foam comprises a compressed memory foam configured to expand to a level of compression sufficient to fill the cavity and to push against the side walls of the cavity.

4. The apparatus of claim 1, wherein the acoustic damping medium comprises a foam, and wherein the foam is configurable by changing foam properties including a material, a shape, a dimension and a density.

5. The apparatus of claim 4, wherein the foam is configured to reduce a distortion and improve a user experience.

6. The apparatus of claim 4, wherein the foam is configured to improve a perceptual rub and buzz (PRB) measure of a distortion.

7. The apparatus of claim 4, wherein the foam is configured to allow the speaker to play louder with reduced low frequency extension.

8. The apparatus of claim 4, wherein the foam is configured to reduce higher order harmonic distortion (HOHD) and intermodulation distortion (IMD) values.

9. The apparatus of claim 4, wherein the foam is configured to increase a production yield and reduce an overall production cost.

10. The apparatus of claim 4, wherein one or more walls of the foam are coated with a material to improve acoustic properties by making the one or more walls acoustically less absorbent or reflective.

11. A mixed reality (MR) device, comprising:
an audio unit comprising:
an output port configured to provide to a user an audio output played by a speaker;
an enclosure configured to contain the speaker and provide a cavity between the speaker and the output port; and
a foam placed in the cavity and configured to cancel acoustic standing waves.

12. The MR device of claim 11, wherein the audio unit is an attachable unit configured to use a universal serial bus (USB) interface.

13. The MR device of claim 11, wherein the foam is configurable by changing foam properties including a material, a shape, a dimension and a density.

14. The MR device of claim 13, wherein the foam is configured to allow the speaker to play louder with a reduced distortion and to improve a user experience.

15. The MR device of claim 13, wherein the foam is configured to improve a PRB measure of a distortion.

16. The MR device of claim 11, wherein the foam is configured to reduce HOHD and IMD values.

17. The MR device of claim 11, wherein one or more walls of the foam are lined with a material to improve acoustic properties by making the one or more walls acoustically less absorbent or reflective.

18. A method, comprising:
providing an audio unit including a speaker and a sound output port contained in an enclosure;
configuring the speaker to receive audio signals and to generate a a soundwave output;
configuring the sound output port to provide the soundwave output to a user;
configuring the enclosure to form a cavity between the speaker and the sound-output port; and
placing the cavity with an acoustic damping medium configured to cancel or reduce acoustic standing waves.

19. The method of claim 18, wherein:
the audio unit is attachable to an MR device via a USB interface, and
the acoustic damping medium comprises a foam and is further configured to dampen vibrations of side walls of the cavity.

20. The method of claim 19, wherein:
the foam is configurable by changing foam properties including a material, a shape, a dimension and a density,
the foam is configured to reduce HOHD and IMD values, and
one or more walls of the foam are coated or lined with a material to improve acoustic properties by making the one or more walls acoustically less absorbent or reflective.
